(19) United States
(12) Patent Application Publication
(10) Pub. No.: US 2019/0103745 A1
(43) Pub. Date: Apr. 4, 2019

(54) Load Controller with Constant Power Mode

(71) Applicant: Ube, Inc. d/b/a Plum, Austin, TX (US)

(72) Inventors: Utz Baldwin, Austin, TX (US); Daniel Kupersztoch, Austin, TX (US); Rich Warwick, Round Rock, TX (US); Glen Burchers, Austin, TX (US); Bryan Lemon, Conway, SC (US)

(21) Appl. No.: 15/723,118

(22) Filed: Oct. 2, 2017

(51) Int. Cl. H02J 3/14; H02J 1/10

(52) U.S. Cl. CPC H02J 3/14; H02J 2001/002; H02J 1/10

(57) ABSTRACT

In one embodiment, the disclosure provides a load control system for providing power to one or more electronic devices, such as a lightbulb. The load control system includes a line terminal, a load terminal, an input interface, and a power output controller. The power output controller is electrically coupled to the line terminal and the load terminal. The power output controller is configured to receive a nominal line voltage at the line terminal, and is further configured to provide a nominal load voltage at the load terminal. The power output controller is configured to receive an input gesture from the input interface, and generate a formatted control signal based at least in part on the input gesture, and an identity of a first controlled device electrically coupled to the load terminal. The power output controller is configured to transmit the formatted control signal to the first controlled device.

### BACKGROUND

The present disclosure relates to control of electrical loads. More specifically, this disclosure relates to in-wall controllers of smart devices, such as bulbs, fans, speakers, and other commercial or residential devices.

### SUMMARY

In one embodiment, the disclosure provides a load control system for providing power to one or more electronic devices, such as a lightbulb. The load control system includes a line terminal, a load terminal, an input interface, and a power output controller. The power output controller is electrically coupled to the line terminal and the load terminal. The power output controller is configured to receive a nominal line voltage, such as 120 Volts AC, at the line terminal. The power output controller is further configured to provide a nominal load voltage, such as 120 Volts AC, at the load terminal. The provided nominal load voltage is substantially equivalent to the received nominal line voltage. That is to say, the nominal line voltage received at the line terminal and the nominal load voltage provided at the load terminal are within an acceptable variance of each other, such as ±5% of a nominal voltage. The power output controller is configured to receive an input gesture from the input interface, and generate a formatted control signal based at least in part on the input gesture, and an identity of a first controlled device electrically coupled to the load terminal. The power output controller may be electrically coupled to the input interface, or may receive an input gesture via one or more wired or wireless networks. The power output controller is configured to transmit the formatted control signal to the first controlled device. Accordingly, one or more controlled devices electrically coupled to the load terminal may receive a constant supply of power in addition to the formatted control signal.

In another embodiment, the disclosure provides a load control system for providing power to one or more controlled devices. The load control system includes a line terminal, a load terminal, an input interface, and a power output controller. The power output controller is electrically coupled to the line terminal and the load terminal. In some embodiments, the power output controller wirelessly transmits a second formatted control signal to a second controlled device. For example, a first smart lightbulb and a second smart lightbulb may be connected in parallel to the load terminal of the load control system. Accordingly, operation of both the first lightbulb and second lightbulb is continuously enabled. The power output controller may generate a first formatted control signal based, at least in part, on an identity of the first lightbulb, for example, a network address. The power output controller may further generate a second formatted control signal based, at least in part, on an identity of the first lightbulb, for example, a network address. Accordingly two or more controlled device coupled to the same load terminal may be controlled independently. Alternatively, the second controlled device may receive power from a separate load terminal, a separate load control system, or separate power distribution circuitry. Accordingly, two or more controlled devices receiving power from disparate power sources may be controlled collectively, or independently, with the load control system.

In another embodiment, the disclosure provides a load control system for providing power to one or more controlled devices. The load control system includes a line terminal, a load terminal, an input interface, and a power output controller. The power output controller is electrically coupled to the line terminal and the load terminal. In some embodiments, the power output controller is configured to receive a formatted data signal from a device electrically coupled to the load terminal, for example, via the network interface. In some embodiments, the power output controller is further configured to receive a formatted data signal transmitted wirelessly from a second controlled device.

In another embodiment, the disclosure provides a load control system for providing power to one or more controlled devices. The load control system includes a line terminal, a load terminal, an input interface, and a power output controller. The power output controller is electrically coupled to the line terminal and the load terminal. In further embodiments, the load terminal is electrically coupled to a smart lightbulb. For example, an LED lightbulb configures to receive, execute, or transmit various commands, functions, or routines over one or more networks. Accordingly, the power output controller may be configured to generate and transmit a formatted control signal comprising one or more of a light toggle signal, a luminance signal, and a light color signal. Accordingly, the constant power supplied at the load terminal enables the smart lightbulb, or other controlled device, to operate, as well as to receive and respond to one or more control signals.

In another embodiment, the disclosure provides a load control system for providing power to one or more controlled devices. The load control system includes a line terminal, a load terminal, an input interface, and a power output controller. The power output controller is electrically coupled to the line terminal and the load terminal. The power output controller may be configured to transmit the formatted control signal to the controlled device via a device bridge.

In another embodiment, the disclosure provides a load control system for providing power to one or more controlled devices. The load control system includes a line terminal, a load terminal, an input interface, and a power output controller. The power output controller is electrically coupled to the line terminal and the load terminal. In some embodiments, the input interface includes one or more push buttons, toggle switches, rotary dials, slide switches, or other suitable user inputs. In some embodiments, the input interface includes a tactile sensor, such as a touchpad. The touchpad may use electrical sensing, such as capacitive or resistive, optical sensing, such as infrared or optical imaging, or any other suitable method. Accordingly, a user may control one or more controlled devices by engaging the input interface. For example, a user may actuate a switch or button to toggle a lightbulb on and off. As another example, a user may simply contact the touchpad to toggle a lightbulb on and off. Alternatively, or in addition, the touchpad may be configured to receive one or more gesture from a user.

Different gestures on the touch-sensitive surface have different contact patterns. Thus, a gesture may be detected by detecting a particular contact pattern. For example, detecting a finger tap gesture includes detecting a finger-down event followed by detecting a finger-up (lift off) event at the same position (or substantially the same position) as the finger-down event. As another example, detecting a finger swipe gesture on the touch-sensitive surface includes detecting a finger-down event followed by detecting one or more finger-dragging events, and subsequently followed by detecting a finger-up (lift off) event. As another example, detecting a finger swipe gesture may include multiple finger contact patterns, such as simultaneous or combinations of finger-down and finger swipe gestures. Accordingly, the user may input a plurality of different gestures associated with respective actions, such as dimming a light, activating a fan, or changing a light color.

In another embodiment, the disclosure provides a load control device which includes a housing and an input interface supported by the housing. Additionally, a line terminal and a load terminal are at least partially retained in the housing. Further, the load control device includes a controller coupled to the input interface, the line terminal, and the load terminal. The controller is configured to receive a nominal line voltage at the line terminal and provide a nominal load voltage at the load terminal. The nominal load voltage is substantially equivalent to the nominal line voltage. The controller is configured to receive an input gesture from the input interface and generate a formatted control signal based at least in part on the input gesture and an identity of a controlled device electrically coupled to the load terminal. The controller is further configured to modulate the formatted control signal onto the nominal load voltage at the load terminal. Accordingly, the load control device may be operable to supply constant power to a controlled device coupled to the load terminal, in addition to providing control signals to the controlled device.

In another embodiment, the disclosure provides a load control device which includes a housing, an input interface supported by the housing, a line terminal at least partially retained in the housing, and a load terminal at least partially retained in the housing. The load control device includes a controller coupled to the input interface, the line terminal, and the load terminal. In some embodiments, the load control device further includes a wireless transceiver coupled to the controller. The controller may be configured to transmit a formatted control signal via the wireless transceiver. In some embodiments, the controller may be configured to wirelessly transmit the formatted control signal to a controlled device electrically coupled to the load terminal. In some embodiments, the controller is configured to modulate a first formatted control signal onto the nominal load voltage provided a first controlled device, as well as being further configured to wirelessly transmit a second formatted control signal to a second controlled device. In some embodiments, the controller is configured to receive a formatted data signal from a device electrically coupled to the load terminal. Alternatively, or in addition, the controller may be configured to receive a formatted data signal transmitted wirelessly from a second controlled device.

In another embodiment, the disclosure provides a load control device which includes a housing and an input interface supported by the housing. Additionally, a line terminal and a load terminal are at least partially retained in the housing. Further, the load control device includes a controller coupled to the input interface, the line terminal, and the load terminal. In some, the load terminal is electrically coupled to a smart lightbulb. Accordingly, the formatted control signal may include one or more of a light toggle signal, a luminance signal, and a light color signal. In various embodiments, the controller may be configured to control other smart home devices such as speakers, thermostats, fans, appliances or any wirelessly connected device—via powerline communication, wireless communication, or both.

In another embodiment, the disclosure provides a load control device which includes a housing and an input interface supported by the housing. Additionally, a line terminal and a load terminal are at least partially retained in the housing. Further, the load control device includes a controller coupled to the input interface, the line terminal, and the load terminal. The controller may be configured to wirelessly transmit the formatted control signal to the controlled device over a device bridge. The formatted control signal may be configured to cause the device bridge to control a second controlled device in wireless communication with the device bridge. Accordingly, the power output controller may be configured to control a controlled device which is not coupled to the load terminal, or control a controlled device from a further distance.

In another embodiment, the disclosure provides a load control device which includes a housing and an input interface supported by the housing. Additionally, a line terminal and a load terminal are at least partially retained in the housing. Further, the load control device includes a controller coupled to the input interface, the line terminal, and the load terminal. In some embodiments, the input interface includes one or more push buttons, toggle switches, rotary dials, slide switches, or other suitable user inputs. In some embodiments, the input interface includes a tactile sensor, such as a touchpad. The touchpad may use electrical sensing, such as capacitive or resistive, optical sensing, such as infrared or optical imaging, or any other suitable method. Accordingly, a user may control one or more electrical devices by engaging the input interface. For example, a user may actuate a switch or button to toggle a lightbulb on and off. As another example, a user may simply contact the touchpad to toggle a lightbulb on and off. Alternatively, or in addition, the touchpad may be configured to receive one or more gesture from a user. Accordingly, the user may input a plurality of different gestures associated with respective actions, such as dimming a light, activating a fan, or changing a light color.

In another embodiment the disclosure provides a method of controlling an electronic device. The method of controlling an electronic device includes selecting a smart-device mode of a control device from a plurality of electronic device control modes. The smart-device mode includes providing a constant load voltage to the electronic device. The method of controlling an electronic device further includes receiving an input gesture, identifying an operational parameter associated with the input gesture, generating a formatted control signal, and transmitting the formatted control signal to the electronic device. The input gesture is received at an input interface, such as a touchpad, associated with the control device, such as an electronic in-wall switch. The input interface and the control device may be electrically coupled, or may communicate over one or more wireless or wired networks. Identifying the operational parameter may include a lookup table, for example, stored in a memory of the control device. In some embodiments, the generating the formatted control signal is based, at least in part, on the operational parameter and an identity of the electronic device. For example, a traditional incandescent bulb may be controllable in a toggle mode or dimming mode, whereas other electronic devices may be controllable in more or fewer modes.

The method further includes generating a formatted control signal based, at least in part, on the action associated with the input gesture. In the case that the control mode is a smart-device mode, a formatted control signal may be generated. The method then includes transmitting the formatted control signal and the constant load voltage from the control device to the electronic device. In some embodiments, in the case that the control mode is a toggle mode or a dimming mode, the method may further include regulating a current associated with the constant load voltage based, at least in part, on the action associate with the input gesture. For example, the control device may include a triac configured to regulate the current provided to the electronic device to dim a light or adjust a fan speed.

In another embodiment the disclosure provides a method of controlling an electronic device. The method of controlling an electronic device includes receiving an input gesture, identifying an action associated with the input gesture, determining a control mode of the control device, generating a formatted control signal, and transmitting the formatted control signal to the electronic device. In some embodiments, the method further includes generating a second formatted control signal based, at least in part, on the action associated with the input gesture, and transmitting the second formatted control signal from a wireless transceiver coupled to the control device. In some embodiments, the method further includes transmitting the formatted control signal and the constant load voltage from the control device to a first electronic device, and further includes transmitting the second formatted control signal to a second electronic device, for example, from a wireless transceiver coupled to the control device. In some embodiments, the method includes receiving a formatted data signal from the electronic device.

In another embodiment the disclosure provides a method of controlling an electronic device. The method of controlling an electronic device includes receiving an input gesture, identifying an action associated with the input gesture, determining a control mode of the control device, generating a formatted control signal, and transmitting the formatted control signal to the electronic device. In some embodiments, the electronic device is an electronic device bridge or hub.

In another embodiment, a method of controlling an electronic device includes receiving an input gesture, identifying an action associated with the input gesture, determining a control mode of the control device, generating a formatted control signal, and transmitting the formatted control signal to the electronic device. The electronic device may comprise a smart lightbulb. Accordingly, the formatted control signal may include one or more of a light toggle signal, a luminance control signal, and a light color signal.

In another embodiment, a method of controlling an electronic device includes receiving an input gesture, identifying an action associated with the input gesture, determining a control mode of the control device, generating a formatted control signal, and transmitting the formatted control signal to the electronic device. In some embodiments, the control device includes a multi-touch input surface, such as a touchpad, which receives the input gesture. Accordingly, the method may enable a user to input a plurality of different gestures associated with respective actions, such as dimming a light, activating a fan, or changing a light color.

Other aspects of the disclosure will become apparent by consideration of the detailed description and accompanying drawings.

### BRIEF DESCRIPTION OF THE DRAWINGS

FIG. 1 a schematic representation of a load control system, according to some embodiments.

FIG. 2 is a perspective view of a load control device, according to some embodiments.

FIG. 3 is a flow chart of a method for controlling an electronic device, according to some embodiments.

FIG. 4 is a flow chart of a method for controlling an electronic device, according to some embodiments.

FIG. 5 is a diagram of an example environment suitable for implementing a load control system according to some embodiments.

### DETAILED DESCRIPTION

Before any embodiments of the disclosure are explained in detail, it is to be understood that the disclosure is not limited in its application to the details of construction and the arrangement of components set forth in the following description or illustrated in the following drawings. The disclosure is capable of other embodiments and of being practiced or of being carried out in various ways. Also, it is to be understood that the phraseology and terminology used herein is for the purpose of description and should not be regarded as limiting. The use of “including”, “comprising”, or “having” and variations thereof herein is meant to encompass the items listed thereafter and equivalents thereof as well as additional items. As used herein, the word “may” is used in a permissive sense (e.g. meaning having the potential to) rather than the mandatory sense (e.g. meaning must). In any disclosed embodiment, the terms “approximately”, “generally”, and “about” may be substituted by “within a percentage of” what is specified, where the percentage includes 0.1, 1, 5, and 10 percent.

Some portions of the detailed description which follow are presented in terms of algorithms or symbolic representations of operations on binary digital signals stored within a memory of a specific apparatus or special purpose computing device or platform. In the context of this particular specification, the term specific apparatus or the like includes a general purpose computer once it is programmed to perform particular functions pursuant to instructions from program software. Algorithmic descriptions or symbolic representations are examples of techniques used by those of ordinary skill in the signal processing or related arts to convey the substance of their work to others skilled in the art. An algorithm is here, and is generally, considered to be a self-consistent sequence of operations or similar signal processing leading to a desired result. In this context, operations or processing involve physical manipulation of physical quantities. Typically, although not necessarily, such quantities may take the form of electrical or magnetic signals capable of being stored, transferred, combined, compared, or otherwise manipulated. It has been proven convenient at times, principally for reasons of common usage, to refer to signals as bits, data, values, elements, symbols, characters, terms, numbers, numerals, or the like. It should be understood, however, that all of these or similar terms are to be associated with appropriate physical quantities and are merely convenient labels. Unless specifically stated otherwise, the terms “processing”, “computing”, “calculating”, “determining” or the like refer to actions or processes of a specific apparatus, such as a special purpose computer or a similar special purpose electronic computing device. In the context of this specification, therefore, a special purpose computer or similar special purpose electronic computing device is capable of manipulating or transforming signals, typically represented as physical electronic or magnetic quantities within memories, registries, or other information storage devices, transmission devices, or display devices of the special purpose computer or similar special purpose electronic computing device. The use of the variable “n” is intended to indicate that a variable number of local computing devices may be in communication with the network.

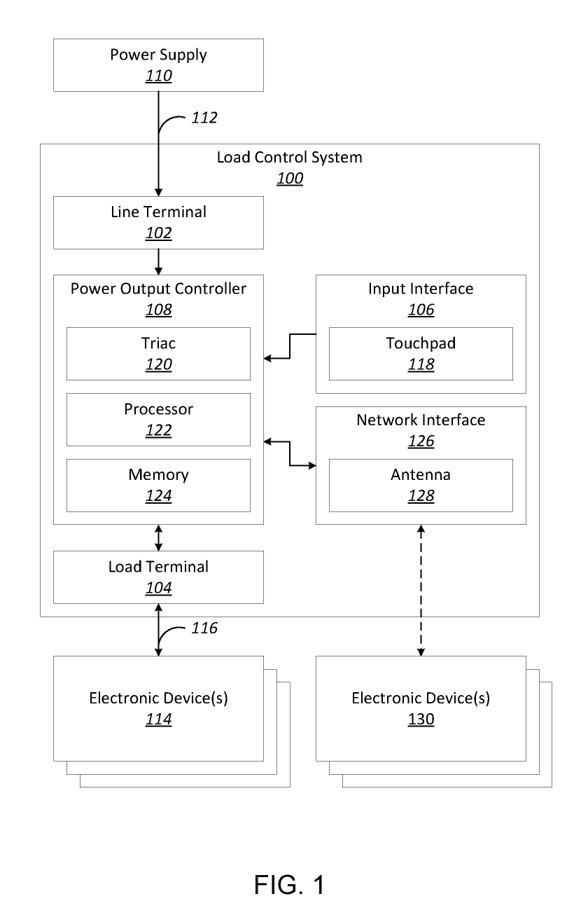

FIG. 1 illustrates a schematic representation of a load control system 100, including a line terminal 102, a load terminal 104, an input interface 106, and a power output controller 108. The line terminal 102 is electrically coupled to a power supply 110 over one or more conductors 112, such as copper wire. In the illustrated embodiment, the power supply 110 delivers a nominal AC voltage of 120 Volts, but the load control system 100 may be configured to receive various nominal AC and/or DC voltages, such as 277 V AC, 48 V DC, or any other suitable voltage. The load terminal 104 is electrically coupled to one or more electronic devices 114, such as, for example, an array of lighting elements or receptacles. In the illustrated embodiment, the electronic devices 114 are connected in parallel with the load terminal 104 over one or more conductors 116. Accordingly, a voltage signal provided at the load terminal 104 is provided to all electronic devices 114. However, in other embodiments, one or more electronic devices 114 may be arranged in a series configuration.

In the illustrated embodiment, the load control system 100 is configured to supply a constant load voltage, such as 120 Volts, to the electronic devices 114 at the load terminal 104. In other embodiments, the load control system 100 may be configured to supply other nominal load voltages. The power output controller 108 is interposed between the line terminal 102 and the load terminal 104. The power output controller 108 is further coupled to the input interface 106 and configured to receive an input gesture from the input interface 106. The power output controller 108 is thus configured to receive a nominal line voltage at the line terminal 102 and provide a nominal load voltage at the load terminal 104. In some embodiments, the nominal line voltage and the nominal load voltage are substantially similar voltages. That is to say, in these embodiments, the load control system 100 behaves as a “closed” switch.

In some embodiments, the power output controller 108 is configured to receive an input gesture from the input interface 106 and generate a formatted control signal based, at least in part, on the input gesture. In some embodiments, the input interface 106 includes a tactile surface, such as Touchpad 118. The term “format” and “formatted” as used herein comprises various aspects of encoding data, such as with different infrastructure and communication protocols (e.g. ZigBee, X10, IPv6, Wi-Fi, Bluetooth, 6LoWPAN, Z-wave, or Bluetooth LE), as well as device addressing and control schemes. By way of example, the power output controller 108 may be configured to generate a formatted control signal based, at least in part, on an identifier of an electronic device 114. The identifier of the electronic device 114 may include important parameters, such as communication protocols the electronic device 114 may respond to, or a plurality of controls or behaviors enabled on the electronic device 114.

In the illustrated embodiment, the power output controller 108 includes a triac 120 configured for regulating a current at load terminal 104 associated with the nominal load voltage provided at the load terminal 104. For example, the triac 120 may be used to “chop” a voltage signal; alternating between permitting and preventing current flow over variable or predetermined portions of a waveform. In some embodiments, it may be advantageous to prevent a current flow while enabling transmission of voltage signals. That is to say, it may be advantageous to limit or prevent the transmission of power between one or more devices while still enabling transmission of control or status signals across the power conductor. In other embodiments, the power output controller 108 includes other circuitry, such as one or more relays, field-effect transistors (FETs), or other suitable circuit elements, configured for controlling or switching a voltage or current. The power output controller 108 may further include at least one processor 122 and a memory 124. The memory 124 program instructions executable by at least one processor 122 of the load control system to perform any of the functionality described herein.

In the illustrated embodiment, the electronic device 114 is a smart device, such as an Internet-of-Things (IoT) enabled lightbulb. Accordingly, it may be advantageous to maintain a constant supply of power to the electronic device 114 so that the electronic device 114 may operate correctly. The power output controller 108 is configured to modulate the formatted control signal onto the load voltage at the load terminal 104. Thus, proper operation of the electronic device 114 is maintained, as well as providing a load control system 100 which may communicate with the electronic device 114 over the conductor 116. In some embodiments, the formatted control signal may include one or more of a light toggle signal, a luminance signal, and a light color signal.

In some embodiments, the load control system 100 further includes a network interface 126, such as a wired or wireless transceiver. In the illustrated embodiment, the network interface 126 includes an antenna 128. In other embodiments, the network interface 126 may include more or fewer antennas 128, or antennas 128 configured for different frequencies. Further, in some embodiments, the load control system 100 may wirelessly communicate with the electronic devices 114, or other electronic devices 130, over the network interface 126. Not all electronic devices 114 and 130 may be identical. It may be desirable to communicate different control signals to different electronic devices 114 and 130, or to communicate to the devices over different channels. Accordingly, the power output controller 108 may be configured to generate a first formatted control signal based, at least in part, on the input gesture, as well as generate a second formatted control signal based, at least in part, on the input gesture. The power output controller 108 may then provide the first formatted control signal and the nominal load voltage at the load terminal 104 to a first electronic device 114. The power output controller 108 may then wirelessly transmit the second formatted control signal to a second electronic device 130.

In some embodiments, the power output controller 108 is configured to receive a formatted data signal from the electronic devices 114 and/or the electronic devices 130. For example, the formatted data signal may be received at the load terminal 104 or at the antenna 128 of the network interface 126. Further, the electronic device 114 may be an electronic device bridge or hub. Thus, the power output controller 108 may be configured to control and communicate with a plurality of electronic devices 130 over the network interface 126, or via the device bridge 114.

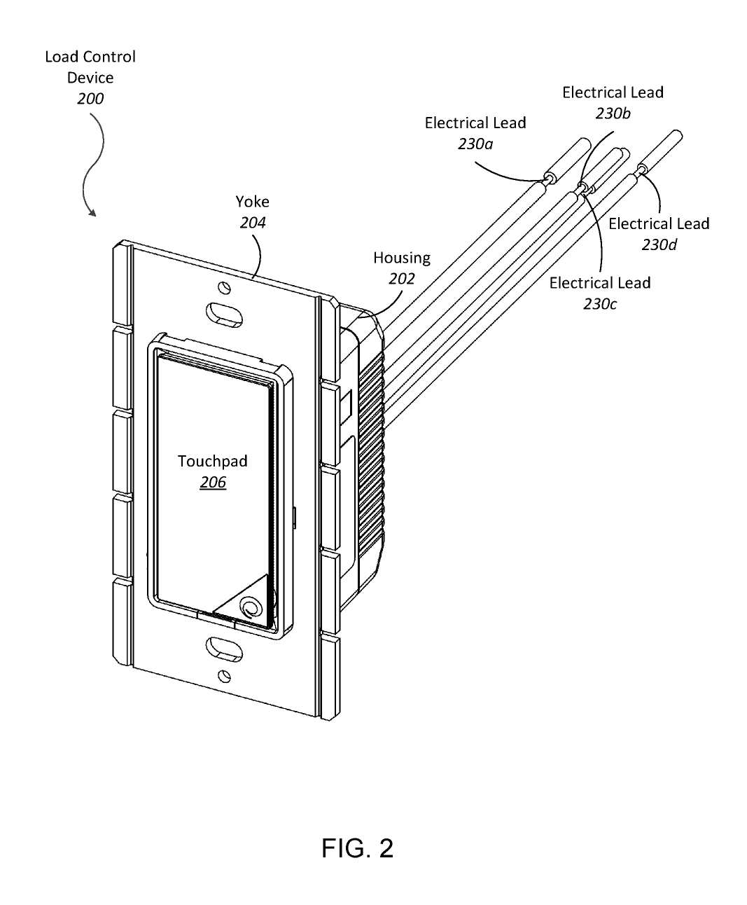

FIG. 2 illustrates a load control device 200, according to some embodiments. The load control device 200 includes a housing 202 that is preferably made from a durable, lightweight, inexpensive, and non-conductive material suitable for the environment in which the switch assembly will operate. A thermoplastic material, such as a resin, or other polymeric substances are examples of materials. The housing may be supported in a conventional electrical box by a yoke 204. In the illustrated embodiment, the load control device 200 is in a single-gang configuration, but may be configured in 2-, 3-, and 4-gang configurations, or any other suitable configuration. Supported by the housing 202, the load control device 200 includes an input interface or touchpad 206 on a front side of the housing 202. At least partially retained within the housing, the load control device 200 includes a line terminal and a load terminal (not shown). For example, screw terminals. Electrical leads 230a-d are coupled to respective electrical terminals within the housing 202. For example, a first electrical lead 230a is coupled to the line terminal, also known as a “hot” or “phase” terminal. The second electrical lead 230b is coupled to the load terminal. The third electrical lead 230c is coupled to a neutral terminal, and the fourth electrical lead 230d is coupled to a grounding terminal.

Further, the load control device 200 includes a controller coupled to the touchpad 206, the line terminal, and the load terminal. The controller is configured to receive a nominal line voltage at the line terminal and provide a nominal load voltage at the load terminal. The controller is configured to receive an input gesture from the touchpad 206 and generate a formatted control signal based at least in part on the input gesture. The controller is further configured to apply the formatted control signal to the nominal load voltage and provide the formatted control signal and the nominal load voltage at the load terminal. Accordingly, the load control device 200 may be operable to supply constant power to an electronic device coupled to the load terminal, in addition to providing control signals to the electronic device.

In some embodiments, the load control device 200 further includes a wireless transceiver coupled to the controller. The controller may be configured to transmit a formatted control signal from the wireless transceiver. In some embodiments, the controller may be configured to wirelessly transmit the formatted control signal to an electronic device electrically coupled to the load terminal or, by extension, the second electrical lead 230b. In some embodiments, the controller is configured to provide a first formatted control signal and the nominal load voltage to a first electronic device electrically coupled to the load terminal, as well as being further configured to wirelessly transmit a second formatted control signal to a second electronic device. In some embodiments, the controller is configured to receive a formatted data signal from a device electrically coupled to the load terminal. Alternatively, or in addition, the controller may be configured to receive a formatted data signal transmitted wirelessly from an electronic device.

In another embodiment, the load terminal is electrically coupled to a smart lightbulb. Accordingly, the controller may be configured to generate and provide a formatted control signal comprising one or more of a light toggle signal, a luminance signal, and a light color signal.

In another embodiment, the load terminal may be electrically coupled to a device bridge. Accordingly, the controller may be configured to supply the nominal load voltage to the device bridge at the load terminal. Further, the controller may be configured to provide a formatted control signal to the device bridge. The formatted control signal may be configured to cause the device bridge to control a second electronic device in wireless communication with the device bridge. Accordingly, the controller may be configured to control an electronic device which is not coupled to the load terminal.

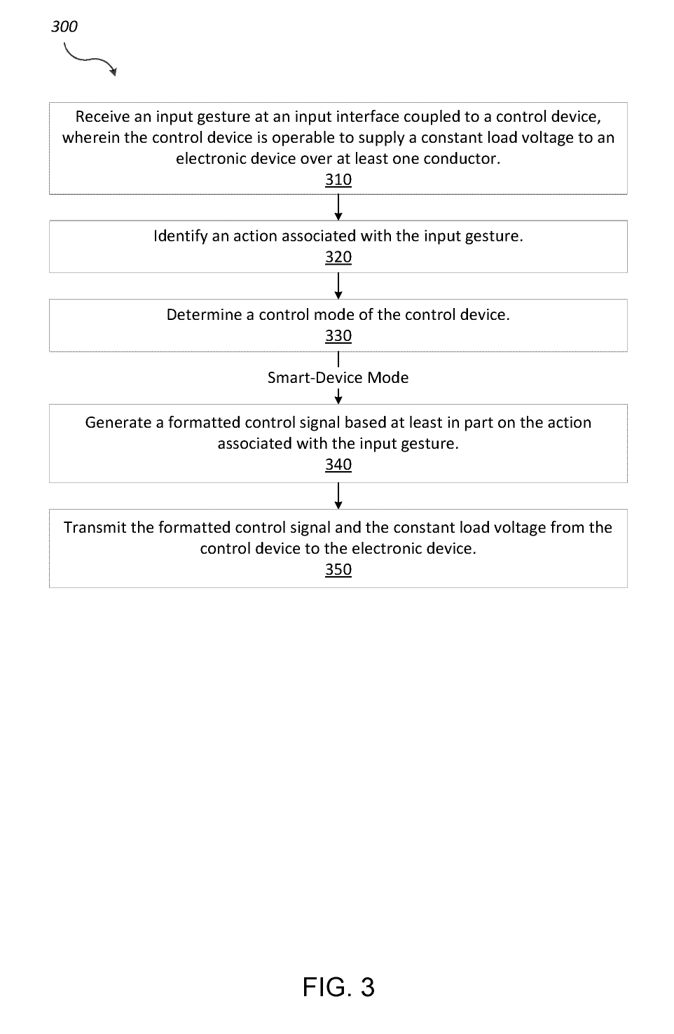

FIG. 3 is a flowchart showing an example method 300 of controlling an electronic device, according to some embodiments. At step 310, an input gesture is received at an input interface coupled to a control device, for example, a touchpad. The control device is operable to supply a constant load voltage to the electronic device over at least one conductor. At step 320, an action associated with the input gesture is identified by the control device. For example, a single upward swiping gesture may be associated with increasing the luminance of one or more lights. At step 330, a control mode of the control device is determined. For example, the control device may use a lookup table or state information stored in a memory of the control device. In the case that the control mode is a smart-device mode, a formatted control signal is generated at step 340. The formatted control signal is generated based, at least in part, on the action associated with the input gesture. At step 350, the formatted control signal and the constant load voltage are transmitted from the control device to the electronic device.

In some embodiments, the method 400 further includes generating a second formatted control signal based, at least in part, on the action associated with the input gesture, and transmitting the second formatted control signal from a wireless transceiver coupled to the control device. In some embodiments, the method further includes transmitting the formatted control signal and the constant load voltage from the control device to a first electronic device, and further includes transmitting the second formatted control signal to a second electronic device, for example, from a wireless transceiver coupled to the control device. In some embodiments, the method includes receiving a formatted data signal from the electronic device.

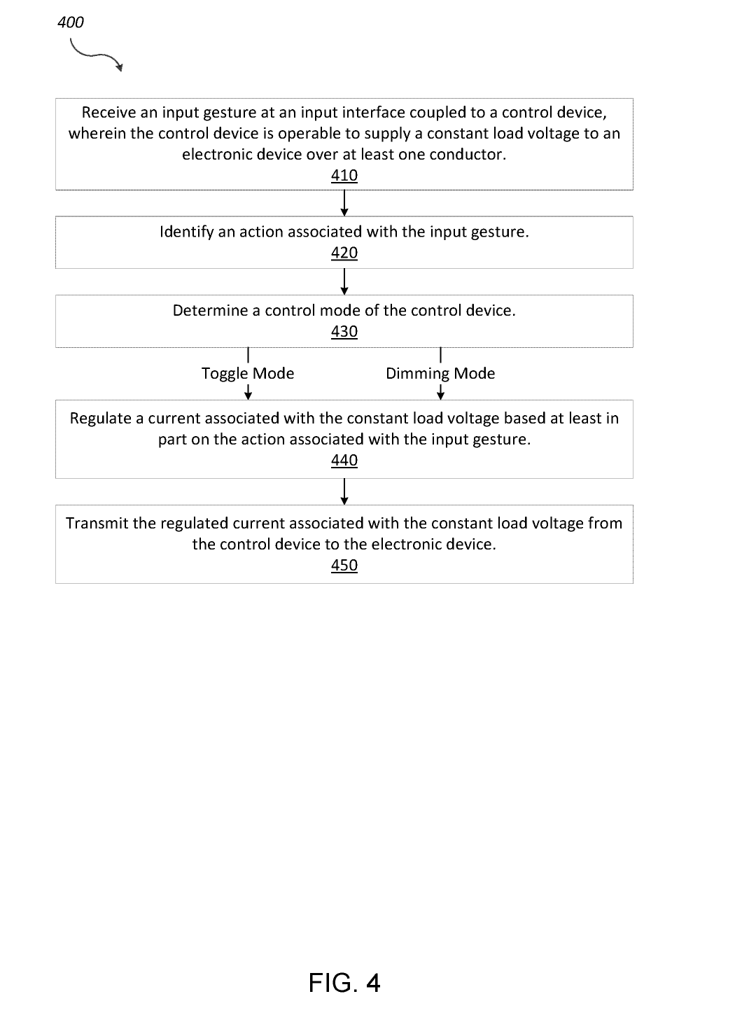

FIG. 4 is a flowchart showing an example method 400 of controlling an electronic device, according to some embodiments. At step 410, an input gesture is received at an input interface coupled to a control device, for example, a touchpad. The control device is operable to supply a constant line voltage to the electronic device over at least one conductor. At step 420, an action associated with the input gesture is identified by the control device. For example, a single upward swiping gesture may be associated with increasing the luminance of one or more lights. At step 430, a control mode of the control device is determined. For example, the control device may use a lookup table or state information stored in a memory of the control device. In the case that the control mode is a toggle mode or a dimming mode, a current associated with the nominal voltage is regulated at step 440, based, at least in part, on the action associated with the input gesture. At step 450, the constant load voltage at the regulated current is transmitted from the control device to the electronic device. In some embodiments, the control device includes a triac configured to regulate the current. Accordingly, both conventional electronic devices as well as smart devices, such as lightbulbs, may be controlled by a single control device, or a plurality of substantially similar control devices.

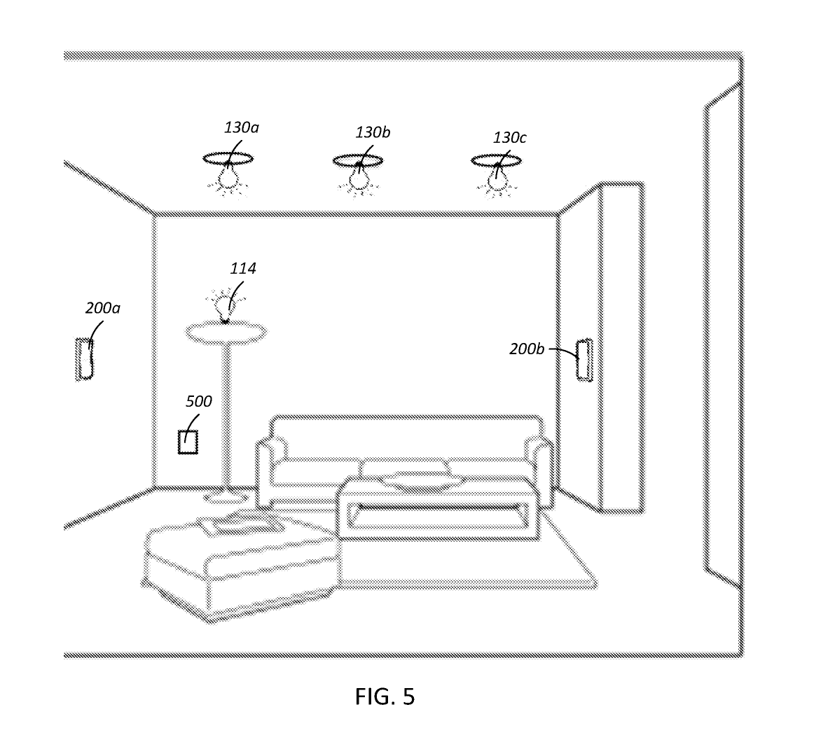

FIG. 5 illustrates a pair of load control devices 200a-b in a residential environment. A first, second, and third controlled devices 130a-c, illustrated as smart lightbulbs, are installed in a ceiling. A fourth controlled device 114, illustrated as an incandescent lamp, is installed in an floor lamp fixture. A wireless device bridge 500 is coupled to a conventional wall outlet. The controlled devices 130a-c are connected in parallel and coupled to the load terminal of the load control device 200b. The controlled device 114 is coupled to the load terminal of the load control device 200a. Accordingly, the load control devices 200a-b may be configured to control one or more of the controlled devices 130a-c and 114 in a plurality of control modes.

In one example, the load control device 200b is configured in a smart-device mode. Accordingly, the load control device 200b supplies a constant voltage to the controlled devices 130a-c. A user may perform an input gesture on the input interface of the load control device 200b. Responsive to the input gesture, the load control device 200b generates and transmits a first formatted control signal to the controlled devices 130a-c to cause them to switch from an illuminated mode to an extinguished mode.

In another example, the load control device 200b may be configured to transmit a formatted control signal to any of the controlled devices 130a-c or the load control device 200a via the device bridge 500. Further, the load control device 200a may be configured in a switch or dimming mode while the load control device 200b remains in the smart-device mode. In the switch mode, the load control device 200a, responsive an input gesture, may selectively enable or disable power provided to the controlled device 114. Similarly, in the dimming mode, the load control device 200a may reduce power provided to the controlled device 114. Accordingly, an input gesture may be received at the input interface of the load control device 200b. The load control device 200b generates and transmits a formatted control signal to the load control device 200a, either directly or via device bridge 500. Responsive to receiving the formatted control signal, the load control device 200a dims the controlled device 114. A similar process may be followed in the opposite direction, wherein the load control device 200a may be used to control one or more of the controlled devices 130a. Accordingly, one or more load control devices 200a-b, operating in a plurality of modes, may be used to directly and indirectly control a plurality of controlled devices 130a-c and 114, which may receive constant power from disparate power sources.

Thus, the disclosure provides, among other things, a load control system for providing power to one or more electronic devices. Various features and advantages of the disclosure are set forth in the following claims.

What is claimed is:

1. A load control system comprising:
a line terminal;
a load terminal;
an input interface; and
a power output controller electrically coupled to the line terminal and the load terminal, the power output controller configured to:
receive a nominal line voltage at the line terminal;
provide a nominal load voltage at the load terminal, wherein the nominal load voltage is substantially equivalent to the nominal line voltage;
receive an input gesture from the input interface;
generate a first formatted control signal, the generating based at least in part on the input gesture and an identity of a first controlled device electrically coupled to the load terminal; and
transmit the first formatted control signal wirelessly to the first controlled device.

2. The load control system of claim 1, wherein the power output controller is further configured to wirelessly transmit a second formatted control signal to a second controlled device.

3. The load control system of claim 1, wherein the power output controller is further configured to wirelessly receive a formatted status data signal from the first controlled device.

4. The load control system of claim 1, wherein the first controlled device comprises a smart lightbulb, and wherein the first formatted control signal is associated with one or more of:
a light toggle signal;
a luminance signal; and
a light color signal.

5. The load control system of claim 1, wherein the power output controller transmits a formatted control signal to an electronic device via a device bridge.

6. The load control system of claim 1, wherein the input interface comprises a multi-touch surface.

7. A load control device, comprising:
a housing;
an input interface supported by the housing;
a line terminal at least partially retained in the housing;
a load terminal at least partially retained in the housing; and,
a controller electrically coupled to the input interface, the line terminal, and the load terminal, wherein the controller is configured to:
receive a nominal line voltage at the line terminal;
provide a nominal load voltage at the load terminal, wherein the nominal load voltage is substantially equivalent to the nominal line voltage;
receive an input gesture from the input interface;
generate a first formatted control signal, the generating based at least in part on the input gesture and an identity of a first controlled device electrically coupled to the load terminal; and
modulate the first formatted control signal onto the nominal load voltage at the load terminal.

8. The load control device of claim 7, further comprising a wireless transceiver coupled to the controller, wherein the controller is further configured to wirelessly transmit a second formatted control signal to a second controlled device.

9. The load control device of claim 8, further comprising a network interface, wherein the controller is further configured to transmit a second formatted control signal to a second controlled device via the network interface.

10. The load control device of claim 7, wherein the controller is further configured to receive a formatted status data signal from the first controlled device.

11. The load control device of claim 7, wherein the first controlled device comprises a smart lightbulb, and wherein the first formatted control signal is associated with one or more of:
a light toggle signal,
a luminance signal, and
a light color signal.

12. The load control device of claim 7, wherein the controller is configured to transmit the formatted control signal to an electronic device via a device bridge.

13. The load control device of claim 7, wherein the input interface comprises a multi-touch surface.

14. A method of controlling a plurality of controlled electronic devices, comprising:
selecting, from a plurality of electronic device control modes associated with a control device, a smart-device mode for controlling a first controlled device;
applying a first load voltage to a terminal electrically coupled to the first controlled device, wherein the first load voltage is held substantially constant;
receiving a first input gesture at an input interface associated with the control device;
identifying a first operational parameter associated with the first input gesture;
generating a first formatted control signal, the generating based, at least in part, on the first operational parameter and an identity of the first controlled device; and
transmitting the first formatted control signal wirelessly from the control device to the first controlled device.

15. The method of claim 14, further comprising:
selecting, from the plurality of electronic device control modes associated with the control device, one of a switching mode or a dimming mode for controlling a second controlled device;
applying a second load voltage to a terminal electrically coupled to the second controlled device;
receiving a second input gesture at the input interface; and
regulating the second load voltage, the regulating based at least in part on a second operational parameter associated with the second input gesture.

16. The method of claim 15, wherein the control device includes one or more of a triac, switch, or field-effect transistor configured for regulating the current associated with the constant load voltage.

17. The method of claim 15, wherein the regulating comprises setting the current to zero.

18. The method of claim 15, further comprising:
generating a second formatted control signal, the generating based at least in part on the second operational parameter and an identity of the second controlled device
transmitting the second formatted control signal wirelessly from the control device to the second electronic device.

19. The method of claim 14, further comprising receiving a formatted status data signal from at least one of the first controlled device or the second controlled device.

20. The method of claim 17, wherein the first controlled device comprises a smart lightbulb, and wherein the first operational parameter is associated with one or more of:
a light toggle signal,
a luminance signal, and
a light color signal.
